(19) United States
(12) Patent Application Publication
(10) Pub. No.: US 2025/0304025 A1
(43) Pub. Date: Oct. 2, 2025

(54) METHOD FOR CONTROLLING A BRAKE SYSTEM, BRAKE CONTROLLER, AND VEHICLE

(71) Applicant: ZF CV Systems Global GmbH, Bern (CH)

(72) Inventor: Julian van Thiel, Grossburgwedel (DE)

(21) Appl. No.: 19/235,442

(22) Filed: Jun. 11, 2025

Related U.S. Application Data
(63) Continuation of application No. PCT/EP2023/083320, filed on Nov. 28, 2023.

(30) Foreign Application Priority Data
Dec. 14, 2022 (DE) 10 2022 133 263.2

(51) Int. Cl. B60T 8/94; B60T 7/12; B60T 8/171; B60T 8/172; B60T 8/1755; B60T 8/88; B60T 17/04; B60W 10/184; B60W 10/20; B60W 30/02

(52) U.S. Cl. CPC B60T 8/94; B60T 7/12; B60T 8/171; B60T 8/172; B60T 8/17551; B60T 8/885; B60T 17/04; B60W 10/184; B60W 10/20; B60W 30/02; B60T 2230/02; B60T 2240/02; B60T 2250/00; B60T 2250/04; B60T 2270/402; B60T 2270/403; B60T 2270/406; B60T 2270/413; B60W 2510/182; B60W 2520/125; B60W 2710/182; B60W 2710/20

(57) ABSTRACT

A method is for controlling a brake system having at least two modulators. A pressure can be modulated via the respective modulator and provided at a connection. The method includes: determining if there is a leak; localizing a detected leak by controlling a modulator with a test signal to change the pressure, and determining a deviation between a target value specified as a function of the signal and an actual value assigned to the connection; if a threshold is exceeded, the line has a leak; controlling a modulator so a flow connection is interrupted between the leaky line and the pressure supply from which the pressure for the connection is modulated; and at a connection to which no line with a located leak is connected, an adjusted pressure is provided, dependent on the braking demand and a deceleration loss from the interruption of the flow connection to the leaky line.

### CROSS-REFERENCE TO RELATED APPLICATIONS

This application is a continuation application of international patent application PCT/EP2023/083320, filed Nov. 28, 2023, designating the United States and claiming priority from German application 10 2022 133 263.2, filed Dec. 14, 2022, and the entire content of both applications is incorporated herein by reference.

### TECHNICAL FIELD

The disclosure relates to a method for controlling a brake system of a vehicle, a brake control unit which is set up to carry out the method, and a vehicle with the brake control unit.

### BACKGROUND

Brake systems in commercial vehicles, especially at a high level of automation, and methods for controlling such brake systems depend on the fact that a condition of the brake system can be reliably detected and that appropriate intervention can be carried out safely in the event of a fault. In particular, leaks can occur in pressure lines of brake systems, resulting in degradation of braking power. If, for example, there is a leak in a pressure line downstream of a modulator that modulates a working pressure from a pressure supply of a pressure medium, the pressure medium can escape from the pressure medium supply via the leak, which then also has an impact on other pressure channels in the brake system that rely on the same pressure medium supply. In order to be able to react quickly and safely to such a leak at higher levels of automation, this must first be detected in order to be able to park the vehicle safely in an appropriate manner before a total failure and to avoid safety risks.

In order to monitor and estimate such leaks in the brake system, various methods are known from the prior art.

For example, from WO 2016/012354 A1 a method and system for identifying a leak in a compressed air system are known with which pressure sensors are used to monitor various areas of a brake system for leaks and a corresponding leak report is issued.

A method for monitoring a brake system of a train is known from the U.S. Pat. No. 6,126,247, in which a pressure change rate is monitored by means of a sensor in the last carriage of the train and sent to the locomotive, where a leak report is made.

DE 102015121480 A1 describes a method for detecting and compensating for a leak in a pressure line that runs between a brake cylinder and an axle modulator, wherein ABS valves are also arranged in the pressure line. After the detection of a leak in the pressure line, the leak is located in particular by controlling the ABS valves, wherein when a leak is located in a part of the pressure line between the brake cylinder and the ABS valve, the ABS valve is permanently brought into the pressure holding position in order to isolate this part of the pressure line from the rest of the brake system and thus avoid an unnecessary escape of pressure medium via the leak. In addition, the pressure can also be limited in pressure lines without a leak in order to avoid or limit undesirable yaw moments during braking.

With all the methods mentioned in the prior art, a leak leads to an undesirable impairment of the braking performance of the brake system, as a loss of deceleration results from the shutdown of the respective section.

### SUMMARY

It is therefore an object of the present disclosure to specify a method for controlling a brake system by means of which a leak can be detected easily and reliably and in the event of a leak a high braking performance of the brake system can continue to be ensured. Furthermore, the object is to provide a brake control unit and a vehicle.

According to the disclosure, the object mentioned is, for example, achieved by a method, a brake control unit and a vehicle according to the disclosure.

According to the disclosure, a method for controlling a brake system of a vehicle is envisaged, wherein the brake system has at least two modulators, wherein by means of the respective modulator and depending on a predetermined (automated by means of an automation system or manually) braking demand which can be zero (unbraked) or non-zero (braking), from a supply pressure prevailing in a pressure medium supply assigned to the respective modulator a working pressure can be modulated and this can be provided to at least one working connection of the respective modulator, wherein at least one pressure line is connected to the respective working connection, which leads directly or indirectly to a consumer (brake cylinder, axle modulator, et cetera) in the respective working group.

The method according to the invention has at least the following steps:
determining if there is any leak in the brake system at all;
localizing a previously detected leak by:
controlling at least one of the modulators with a test control signal in which a test target pressure is encoded, in such a way that there is a change in the working pressure provided depending on the present braking demand (zero or non-zero) at a working connection of the respective modulator to be tested, and
determining a deviation (or a variable characterizing the deviation) between a target value specified as a function of the test control signal and an actual value assigned to the working connection to be tested, which occurs as a result of the control of the respective modulator with the test control signal, so that a certain deviation can be assigned to each working connection, which are preferably tested one after the other,
wherein, in the event that the determined deviation exceeds a localization threshold value, a leak is located in that pressure line which, during the control of the respective modulator with the test control signal, has an open flow connection with the working connection to which this localization threshold-exceeding deviation is assigned;
controlling at least one of the modulators of the brake system in such a way that:
a flow connection between the pressure line with the located leak and the pressure medium supply from which the working pressure for the working connection connected to this pressure line is modulated; is interrupted, preferably permanently, for example by bringing an inlet valve-outlet valve combination upstream of the working connection into the pressure holding position; and
at one or more of the working connections to which no pressure line with a located leak is connected, an adjusted working pressure is provided, which depends on the specified braking demand (unbraked or braked) and on a loss of deceleration resulting from the aforementioned interruption of the flow connection to the pressure line with the located leak.

According to the invention, a brake control unit for carrying out the method according to the invention and a vehicle with this brake control unit are also provided.

Advantageously, therefore, after a leak has been detected, high braking performance is achieved by deactivating the relevant pressure channel or pressure line or cutting it off from the rest of the brake system, so that the pressure medium cannot escape from the pressure medium supply through the leak. This means that the leak does not affect other pressure channels or pressure lines that are supplied by the same pressure medium supply. Furthermore, the degradation of the braking power, which occurs in the event of a braking demand due to shutting down or deactivation of the pressure line with the leak, is then compensated by an adapted pressure control at the other pressure channels that are not directly affected by the leak. This means that high braking performance can continue to be achieved. This method is particularly advantageous for automatically operated (commercial) vehicles, with which a leak can be detected quickly and reliably by the system itself and subsequently a detected and located leak can be reacted to quickly and safely.

Preferably, it is envisaged that to the one or more working connections to which no pressure line with a located leak is connected, an adjusted working pressure is provided depending on the braking demand in such a way that the deceleration loss resulting from the interruption of the flow connection to the pressure line with the located leak is fully compensated or at least reduced. The aim is therefore to ensure that the adapted pressure control has no or a minimized effect on the deceleration of the vehicle.

It may then also preferably be provided that to the one or more working connections to which no pressure line with a located leak is connected, an adjusted working pressure is provided depending on the braking demand in such a way that a lateral dynamic influence, for example a yaw rate of the vehicle and/or a lateral acceleration of the vehicle, which results solely from an interruption of the flow connection to the pressure line with the located leak, is fully offset or at least reduced. So not only the reduced deceleration performance is considered, but also a stability-critical part that could lead to a loss of lateral control, which increases or maintains driving safety. This can be carried out, for example, by means of a stability system that monitors or estimates the system response and limits the working pressure on the at least one working connection that does not have a pressure line connected to a located leak, and then also limits the resulting lateral dynamic influence. In addition, an adjustment of the working pressure can only be allowed at certain working connections, for example on the same side of the vehicle as the pressure line with the leak.

Preferably, it may then continue to be provided that in addition a steering demand is output to a steering system in the vehicle, wherein the steering demand is preferably generated in coordination with the adjusted working pressure in such a way that the lateral dynamic influence resulting from an interruption of the flow connection to the pressure line with the located leak is compensated or at least reduced. If, therefore, an additional yaw rate acts on the vehicle due to shutting down a pressure channel and/or due to adjusting the pressure control at the other pressure lines or working connections, a corresponding opposite steering is effected by means of the steering system, which compensates for this additional yaw rate, at least partly. In this way, the stability of the vehicle can be ensured and thus safe driving can be guaranteed.

Preferably, it is also envisaged that, after locating a detected leak, the specified braking demand is adjusted, in particular reduced, depending on the detected deceleration loss, preferably in such a way that the deceleration loss resulting from the interruption of the flow connection to the pressure line with the located leak L) can be completely compensated or at least reduced by providing an adjusted working pressure at the at least one working connection to which no pressure line with a located leak is connected. Therefore, if it is determined that adapted pressure control is not possible, the braking demand is adjusted or reduced in order to react to the changed situation and still ensure safe driving, for example with correspondingly lower deceleration combined with changed routing and/or speed of the vehicle.

Preferably, it is also provided that after locating a detected leak, the following is still provided:
checking a shutdown criterion for the working connection to which the pressure line containing the located leak is connected,
wherein the flow connection to the pressure line with the located leak is only interrupted if the shutdown criterion is met. Advantageously, the working connection is not shut down in every case, but only when defined criteria are met.

Here it may preferably be provided that, in order to meet the shutdown criterion, it is checked beforehand whether an adapted working pressure can be provided at the at least one working connection of the respective modulator to which no pressure line with a located leak is connected, in such a way that, in the event of a braking demand, the loss of deceleration due to the interruption of the flow connection to the pressure line with the located leak can be fully compensated or at least reduced, wherein a compensation or reduction of the lateral dynamic influences can also be checked at this point in time. It is therefore already checked for the respective driving situation to see whether it is possible to compensate for the lost braking effect for a certain braking demand. In this way, it can be decided depending on the situation whether an escape of the pressure medium or better a reduced braking power should be accepted, and the vehicle can then be parked immediately or continue to be operated under certain conditions.

Preferably, it is then also provided that, in order to meet the shutdown criterion, it is also checked whether a further working pressure for another working connection of the same modulator and/or another modulator of the brake system is modulated from the pressure medium supply from which the working pressure for the working connection connected to the pressure line with the located leak is modulated, wherein the shutdown criterion is preferably met if this is the case (two working connections are supplied from the same pressure medium supply) and the deceleration loss can at least be reduced by an adjusted working pressure. It is therefore taken into account that no deactivation of the pressure channel would have an influence on the other pressure channels and therefore it is better to accept at least a slight deterioration in braking performance, since under certain circumstances an influence on the other pressure channels would mean a further deterioration in the braking performance of the vehicle, at least in the long term.

Preferably, it is also envisaged that, in order to meet the shutdown criterion, it is also checked whether the pressure line with the located leak is assigned to a front axle or a rear axle in order to estimate the deceleration loss. Accordingly, axle loads can also be taken into account, wherein the deactivation of a front axle has a smaller influence on the deceleration than the rear axle with a higher load.

Preferably, it is also envisaged that, if the shutdown criterion is met, at least one shutdown condition is additionally defined and output, wherein the shutdown condition includes, for example, a limitation of the speed of the vehicle and/or at least a partial lifting of the affected vehicle axle and/or an adjustment of the trajectory planning, for example greater distances to objects or other road users. The shutdown is therefore linked to conditions in order to continue to enable safe driving with high braking power after the shutdown.

Preferably, it is also envisaged that the actual value assigned to the working connection to be tested:
is an actual deceleration that results from the control of the respective modulator with the test control signal for the vehicle and which follows, for example, from the measured wheel speeds or another speed measurement (by differentiation) or an acceleration measurement, and/or
is an actual slip that results from the control of the respective modulator with the test control signal on a wheel assigned to the respective working connection to be tested and which follows, for example, from the measured wheel speeds, and/or
is an actual pressure that is set as a result of the control of the respective modulator with the test control signal at the respective working connection to be tested or in the pressure line connected to it and which results from a sensor measurement, for example in the respective modulator before the respective working connection.

Consequently, the deviation is then:
a pressure deviation between a test target pressure, which is encoded in the test control signal, for example, and the actual pressure, and/or
is a slip deviation between a target slip resulting from the test target pressure and the actual slip, and/or
is a deceleration deviation between a target deceleration of the vehicle resulting from the test target pressure and the actual deceleration of the vehicle, wherein the localization threshold value or indication threshold value then consequently relates to the respective physical magnitude of the deviation.

A number of variables can therefore be considered in order to characterize the respective driving situation and the resulting deviation from the target value. In this way, both an indication and a localization of a leak are possible, then with a different objective in each case when evaluating the deviation.

Preferably, it is also envisaged that the test control signal is generated in such a way that:
if there is a braking demand of zero (unbraked), the working pressure at the respective working connection to be tested is increased towards a test target pressure encoded in the test control signal, preferably in a pulse-like manner, for example to 500 mbar, wherein this is preferably done in such a way that there is a minimal influence on the speed of the vehicle, for example zIst<0.1 m/s², or
if there is a braking demand of non-zero (braked), the working pressure at the respective working connection to be tested is reduced, preferably to an ambient pressure, especially in a pulse-like manner. This means that a test brake system suitable for the respective situation is specified, wherein the influence is kept as low as possible. For this purpose, it may also be provided that in the event of a reduction of the working pressure at the respective working connection to be tested, that is, in the already braked state, a compensation control signal is generated and output to at least one of the modulators in such a way that the working pressure provided at the respective untested working connection is increased, in order to compensate for the reduction of the working pressure at the respective working connection to be tested. Even during test braking to locate the leak, a reduction in braking power is already avoided.

Preferably, it is also envisaged that the method will be stopped or paused if the working pressure provided at the respective working connection that has not been tested cannot be increased further as a result of the control with the compensation signal. If it is not possible to compensate for the degradation of the braking power during the localization of the leak, this is postponed to a later point in time so as not to adversely affect the current driving operation, where there already appears to be very strong braking, which may include a dangerous situation.

Preferably, it is also envisaged that during the localization of a detected leak, the test control signal is generated and output in such a way that there is a change in the working pressure as a result of the test control signal at only a working connection to be tested within the brake system. The individual working connections are therefore tested one after the other or in sequence in order not to detect any reciprocal influences and to enable exact localization of the leak.

It is also preferable that the determination of whether there is a leak in the brake system is carried out by determining, in the presence of a non-zero braking demand (braked) which differs from the test braking (no braking demand from the automation system), whether a target value specified as a function of this braking demand is different from an actual value which is set as a result of the control of the respective modulator with the present braking demand by more than an indication threshold. In this case, too, known and easily measurable values are used to draw a conclusion regarding the existence of a leak (which has not yet been localized more precisely).

Preferably, it is also provided that the detection of a leak and/or the localization of a leak is continuously checked. This allows new leaks or incorrectly detected leaks to be detected and responded to accordingly.

It is also preferable that a detected and/or located leak is stored in a non-volatile fault memory of the brake system. This means that even after a start/restart of the brake system, a previously detected leak and also the subsequent reaction can be used, so that the occurrence and localization can be validated if necessary.

### BRIEF DESCRIPTION OF DRAWINGS

The invention will now be described with reference to the drawings wherein:

FIG. 1 shows a schematic view of a brake system of a vehicle;

FIGS. 2, 3, 4 show schematic views of the brake system from FIG. 1 with leaks in different pressure lines;

FIG. 5 shows a modulator of the brake system of FIGS. 1 to 4; and,

FIG. 6 shows the sequence of the brake control method according to the invention.

### DETAILED DESCRIPTION

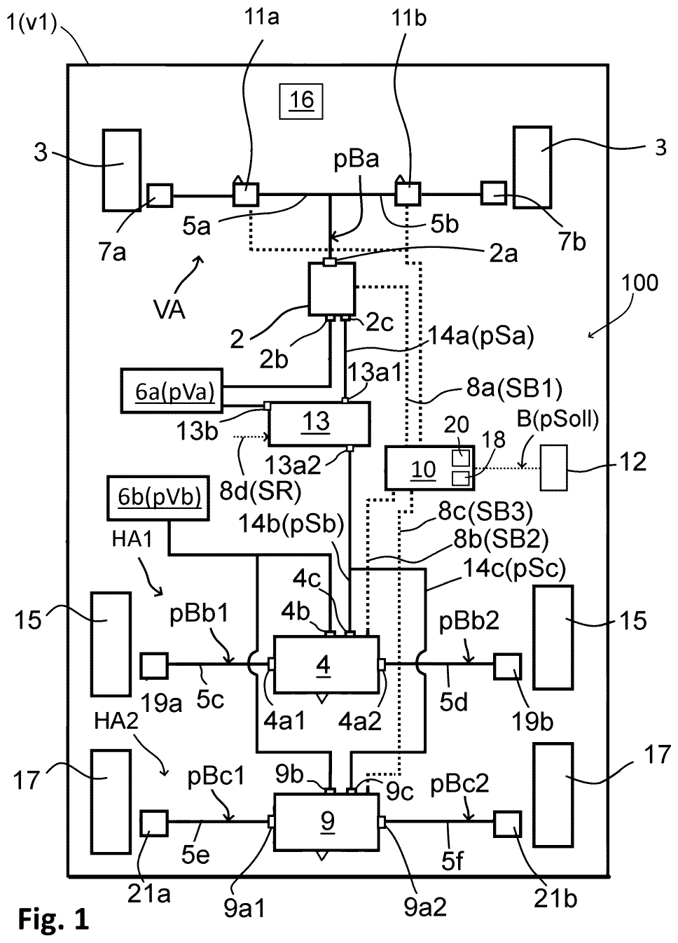

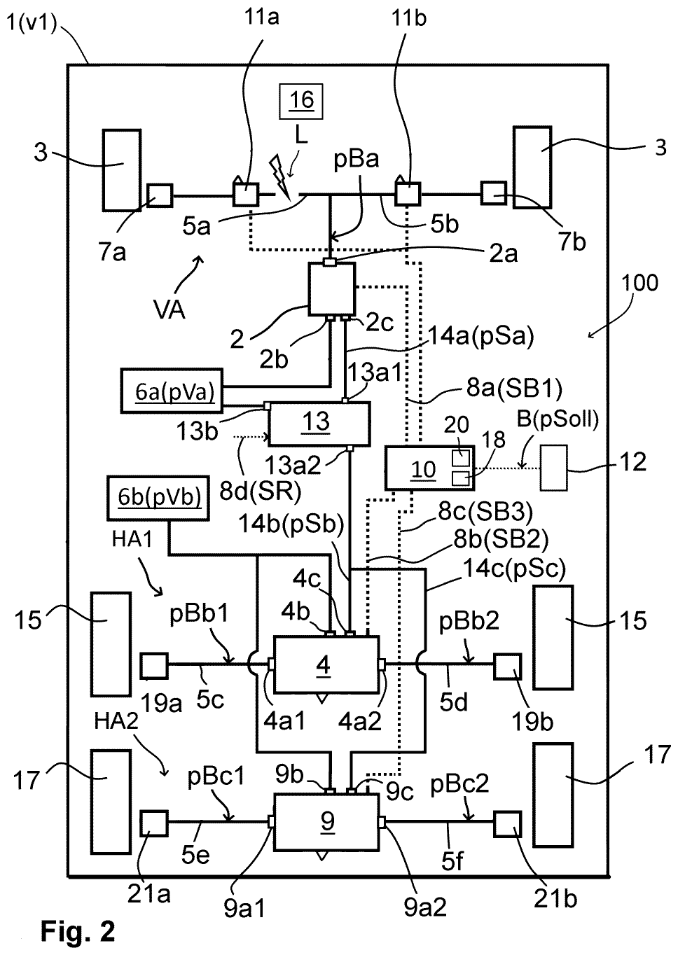

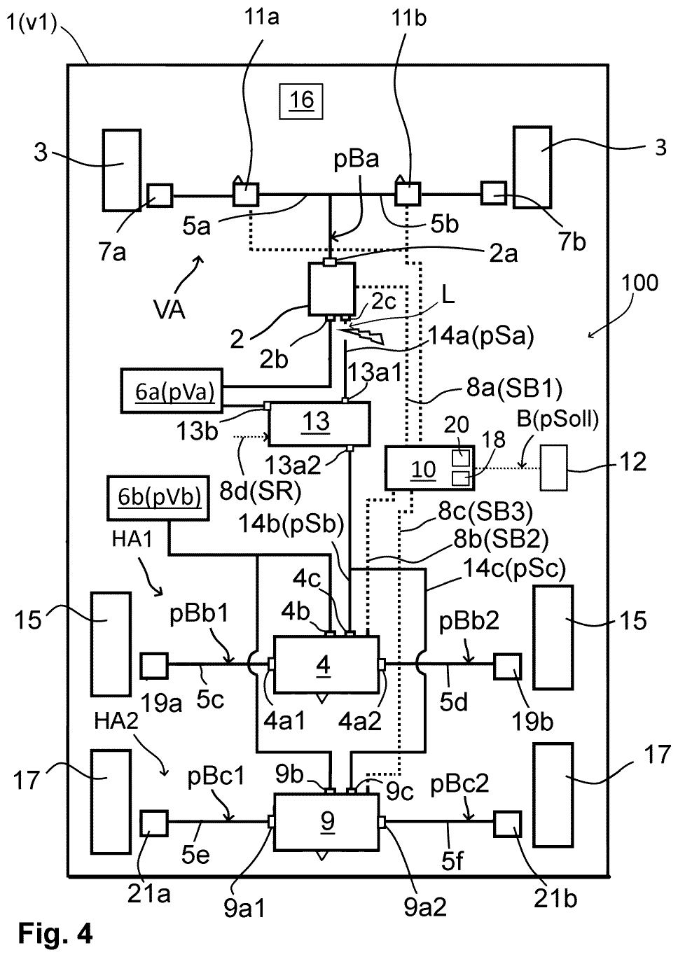

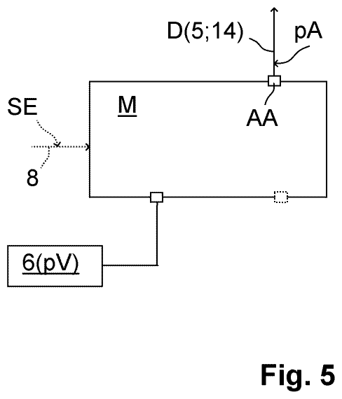

FIG. 1 shows a schematic view of a brake system 100 of a vehicle 1 and FIG. 5 shows details of a modulator M of the brake system 100, where electrical control cables 8; 8a, 8b, 8c, 8d are represented by dotted lines, while pneumatic pressure lines D (brake pressure lines 5; 5a-5f, and control pressure lines 14; 14a-14c) are shown as solid lines. Only components of the brake system 100 relevant for the description of the invention are presented. According to the invention, it is intended that leaks L can be detected in some of the pneumatic pressure lines D, wherein the brake system 100 shown in FIG. 1 initially has no such leak L. The following FIGS. 2, 3 and 4 show possible leaks L in the pneumatic pressure lines D, which can be detected by the method according to the invention.

The vehicle 1 has wheels 3 on a front axle VA and wheels 15, 17 on two separate rear axles HA1, HA2, wherein each wheel 3, 15, 17 is assigned a brake cylinder 7, 19, 21, by means of which the respective wheel 3, 15, 17 can be braked individually. The left and right brake cylinders 7a, 7b on the wheels 3 of the front axle VA are each connected downstream of a left ABS valve 11a or a right ABS valve 11b in a (left) first brake pressure line 5a and in a (right) second brake pressure line 5b, respectively, by means of which wheel-specific ABS control (pressure maintenance, pressure build-up, pressure reduction) can be carried out on the front axle VA in a known manner.

The ABS valves 11a, 11b on the front axle VA are also connected downstream of a first axle modulator 2, by means of which a first brake pressure pBa is modulated into the first or second brake pressure lines 5a, 5b and via it to the ABS valves 11a, 11b via a working connection 2a. The first axle modulator 2 is connected to a brake control unit 10 via a first electrical control cable 8a. The brake control unit 10 electrically controls the first axle modulator 2 assigned to the front axle VA by means of a first brake control signal SB1, depending on a braking demand B automatically specified by an automation system 12, for example, in order to then modulate a corresponding first brake pressure pBa from a first pressure medium supply 6a assigned to the front axle VA (first supply pressure pVa) via an inlet valve/outlet valve combination in the first axle modulator 2 and provide it at the working connection 2a. For this purpose, the first axle modulator 2 is also pneumatically connected to the first pressure medium supply 6a via a pressure medium connection 2b.

The two rear axles HA1, HA2 of the vehicle 1 are also assigned a second axle modulator 4 and a third axle modulator 9 respectively. The respective axle modulator 4, 9 is electrically controlled via a second or third electrical control cable 8b, 8c by the brake control unit 10 by means of a second or third brake control signal SB2, SB3 depending on the braking demand B, which is automatically specified by the automation system 10, for example, wherein the brake pressure pBb1, pBb2, pBc1, pBc2, modulated in the respective axle modulator 4, 9 by an inlet/outlet valve combination from a second pressure medium reservoir 6b assigned to the rear axles HA1, HA2 (second reservoir pressure pVb) and provided at the respective working connection 4a1, 4a2, 9a1, 9a2, is already subjected to wheel-specific ABS control. For this purpose, the second and third axle modulators 4, 9 are each pneumatically connected to the second pressure medium reservoir 6b via a pressure medium connection 4b, 9b.

The second axle modulator 4 assigned to the first rear axle HA1 has a first working connection 4a1, which is pneumatically connected via a (left) third brake pressure line 5c to the left brake cylinder 19a on the left wheel 15 of the first rear axle HA1. The provided left second brake pressure pBb1 can be transferred via this. The second axle modulator 4 assigned to the first rear axle HA1 also has a second working connection 4a2, which is pneumatically connected to the right brake cylinder 19b on the right wheel 15 of the first rear axle HA1 via a (right) fourth brake pressure line 5d. The right second brake pressure pBb2 can be transmitted via this. In this way, wheel-specific brake pressure control is provided on the first rear axle HA1.

In a comparable way, the third axle modulator 9 assigned to the second rear axle HA2 has a first working connection 9a1, which is pneumatically connected via a (left) fifth brake pressure line 5e to the left brake cylinder 21a on the left wheel 17 of the second rear axle HA2. The provided left third brake pressure pBc1 can be transferred via this. The third axle modulator 9 assigned to the second rear axle HA2 also has a second working connection 9a2, which is pneumatically connected to the right brake cylinder 21b on the right wheel 17 of the second rear axle HA2 via a (right) sixth brake pressure line 5f. The right third brake pressure pBc2 can be transferred via this. In this way, wheel-specific brake pressure control is also provided on the second rear axle HA2.

The axle modulators 2, 4, 9 described above also have a redundancy connection 2c, 4c, 9c each, via which the respective axle modulator 2, 4, 9 is pneumatically connected to a redundancy modulator 13. The redundancy modulator 13 has a first working connection 13a1, a second working connection 13a2 and a pressure medium connection 13b. For example, the redundancy modulator 13 is also pneumatically connected to the first pressure medium supply 6a via the pressure medium connection 13b. The first working connection 13a1 is pneumatically connected via a first control pressure line 14a to the redundancy connection 2c of the first axle modulator 2 assigned to the front axle VA. The second working connection 13a2 of the redundancy modulator 13 is pneumatically connected via a second control pressure line 14b to a redundancy connection 4c of the second axle modulator 4 assigned to the first rear axle HA1 and via a third control pressure line 14c to a redundancy connection 9c of the third axle modulator 9 assigned to the second rear axle HA2. In the second and third control pressure lines 14c, the same pressures are transmitted according to this configuration.

In the event of redundancy in the event of an electrical failure or defect of the brake control unit 10, the redundancy modulator 13 can be electrically controlled via a fourth electrical control cable 8d with a redundancy control signal SR, which is also generated depending on a preferably automatically specified braking demand B, in order to modulate a control pressure pSa, pSb, pSc to the redundancy connections 2c, 4c, 9c of the axle modulators 2, 4, 9 on the respective vehicle axle VA, HA1, HA2 via the working connections 13a1, 13a2 thereof and the control lines 14a, 14b, 14c connected thereto. In the respective axle modulators 2, 4, 9, a corresponding brake pressure pBa, pBb1, pBb2, pBc1, pBc2 can then be controlled at the respective working connection 2a, 4a1, 4a2, 9a1, 9a2 at this pneumatic fallback level depending on the respective control pressure pSa, pSb, pSc.

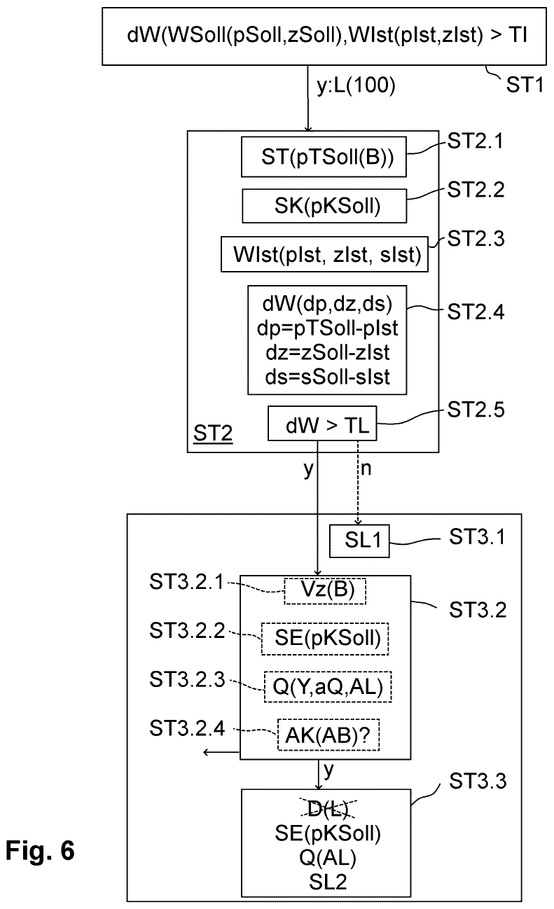

In a brake system 100 constructed in this way with several modulators M (2, 4, 9, 13) in accordance with FIG. 5 and working connections AA (2a, 4a1, 4a2, 9a1, 9a2, 13a1, 13a2) arranged thereon, by means of which a working pressure pA (pBa, pBb1, pBb2, pBc1, pBc2, pSa, pSb, pSc) modulated from a supply pressure pV (pVa, pVb) can be modulated in pressure lines D (5 (5a-5f), 14 (14a-14c)), leaks L can be detected according to the following method shown in FIG. 6 on the basis of a flow diagram. Leaks L relevant to the method are mainly larger leaks or pneumatic line breaks in the pressure lines D, in which the pressure media is transferred over a large cross-section. It is also characteristic that the respective leak L is only present in braked or pressurized operation if a working pressure pA modulated from the respective pressure medium supply 6 is modulated by the respective modulator M via the respective working connection AA.

For this purpose, in an indication step ST1 it is first determined whether there are any signs of a leak L in the brake system 100. This is done by means of a suitable target/actual comparison, that is, on the basis of a target value WSoll specified in the brake system 100 and a measured actual value WIst of the same physical variable (pressure, speed, acceleration). A deviation dW resulting from this target/actual comparison, for example a pressure deviation dp and/or a deceleration deviation dz, then serves as an indicator for or against a leak L in one of the pneumatic pressure lines D.

Accordingly, for example, a target pressure pSoll for a certain pressure channel or pressure line D and/or a target deceleration zSoll of the vehicle 1 resulting from a certain specified braking demand B can be used as the target value WSoll. Consequently, the actual value is then an actual pressure pIst of the respective pressure channel or pressure line D and/or an actual deceleration zIst of the vehicle 1, which result in the presence of the braking demand B from the subsequent control of the respective modulator M and which can be determined by a corresponding sensor (pressure, speed, acceleration) or by means of modelling.

If, in the presence of any braking demand B, there is no deviation dW or a deviation dW that is below a tolerance-related indication threshold value TI for the respective physical variable, there is also no indication of a leak L. If, however, a deviation dW of more than the tolerance-related indication threshold value TI is determined in the target/actual comparison, the existence of a leak L is concluded in the course of the method, since the desired braking effect/brake pressure cannot be achieved. Examples of leaks L that can be detected in this way are shown in FIGS. 2 (first brake pressure line 5a) and 3 (fifth brake pressure line 5e) and 4 (first control pressure line 14a).

In order to investigate this further, the leak L is localized in more detail in the subsequent localization step ST2 by controlling the brake system 100 in a modified form as follows.

In a first localization step ST2.1, the individual modulators M of the brake system 100 are successively or sequentially controlled by the brake control unit 10 via the respective electrical control cable 8 by means of a test control signal ST in such a way that there is a change in the working pressure pA provided at the respective working connections AA one after the other or consecutively.

According to an embodiment with which, in addition to the test control signal ST, no other electrical control signal SE (SB1, SB2, SB3, SR) is transferred to the respective modulator M via the respective electrical control cable 8, that is, the vehicle 1 is not being actively braked due to a braking demand B of greater than zero (normal or redundant), the test control signal ST is generated in the brake control unit 10 in such a way that the respective modulator M briefly (for example for a period of 50 ms to 300 ms) or in a pulsed manner modulates an increased working pressure pA at the respective working connection AA to be tested. For this purpose, a corresponding test-target pressure pTSoll can be coded in the test control signal ST, depending on which the respective modulator M then controls the integrated inlet valve/outlet valve combination before the respective working connection AA to be tested, preferably with alternate pressure build-up and pressure reduction, so that the increased brake pressure working pressure pA is briefly established at the respective working connection AA to be tested in accordance with the specified test target pressure pTSoll, preferably in multiple pulses.

The test target pressure pTSoll encoded in the test control signal ST is chosen in such a way that the working pressures pA then provided and modulated into the pressure line D are ideally so small that they have no major (but at least a demonstrable) influence on a speed v1 of the vehicle 1. This is the case, for example, with test target pressures pTSoll of less than 500 mbar.

According to another embodiment, the test control signal ST is transferred to the respective modulator M, while any braking demand B is being implemented, that is, the vehicle 1 is already being actively braked (in normal operation or in the case of redundancy). In this case, the test control signal ST is selected in such a way that individual working connections AA are shut down one after the other for a short time (period from 50 ms to 300 ms), that is, the working pressure pA that has already been modulated due to the braking demand B is reduced for a short time, for example to ambient pressure, preferably in several pulses. For the respective modulator M, a test target pressure pTSoll is encoded in the test control signal ST, which roughly corresponds to the ambient pressure. The inlet valve/outlet valve combination upstream of the respective working connection AA to be tested is briefly brought into the pressure reduction position (pulsating several times). In this case, a target pressure pSoll transferred via the respective electrical control signal SE (SB1, SB2, SB3, SR) depending on the braking demand B is overwritten or overridden by the test target pressure pTSoll.

In an optional second localization step ST2.2, the short-term reduction of the already modulated working pressure pA at the respective working connection AA to be tested caused by the test control signal ST is compensated by a short-term increase in the working pressure pA at one or more of the other working connections AA that are not to be tested. If, therefore, in the first localization step ST2.1 a reduced test target pressure pTSoll for the respective working connection AA to be tested is encoded in the test control signal ST for one of the modulators M, a correspondingly increased compensated target pressure pKSoll is encoded in a compensation control signal SK for the at least one other, currently untested working connection AA. In this case, a target pressure pSoll transferred via the respective electrical control signal SE (SB1, SB2, SB3, SR) depending on the braking demand B is overwritten or overridden by the compensated target pressure pKSoll.

If an increased, compensated target pressure pKSoll cannot be implemented via at least one of the other AA working connections that are not to be tested, because a maximum possible target pressure pSoll is already being provided or modulated due to the present braking demand B and/or emergency braking is in progress, then it is preferable to stop or interrupt the method in localization step ST2.

In a third localization step ST2.3, the system reaction to the respective test control signal ST or the respective test target pressure pTSoll is then observed in order to determine the pressure channel or pressure line D affected by the leak L. For this purpose, comparable to the indication of the leak L as an actual value Wist, an actual pressure pIst that indicates the actual working pressure pA that is modulated by the working connection AA to be tested can be determined. For this purpose, the pressure sensor integrated in the respective modulator M can be used. In addition or alternatively, the actual value WIst can also be determined as an actual slip sIst, which results for the respective wheel 3, 15, 17 assigned to the working connection AA to be tested, or the actual deceleration zIst of the vehicle 1 can be determined. As usual, the actual slip sIst for the respective wheel 3, 15, 17 can be calculated from the wheel speeds determined by sensors.

In a fourth localization step ST2.4, a deviation dW between the actual value WIst (pIst, sIst, zIst) of the respective working connection AA to be tested and the target value WSoll (pTSoll, sSoll, zSoll) is determined for the respective modulated test control signal ST. A target slip sSoll and the target deceleration zSoll result from the test control signal ST, for example via the respective test target pressure pTSoll. In this way, a deviation dW between the respective values WIst, WSoll can be assigned to each working connection AA, that is, a pressure deviation dp =pTSoll-pIst and/or a slip deviation ds=sSoll−sIst and/or a deceleration deviation dz=zSoll−zIst.

In a subsequent fifth localization step ST2.5, the deviations dW for each working connection AA are then compared with a tolerance-related localization threshold value TL for the respective physical variable. If the deviation dW for a tested working connection AA is greater than the tolerance-related localization threshold value TL, it can be concluded that there is a leak L in the pressure channel or in the pneumatic pressure line D that is connected to the tested working connection AA with dW>TL or that has an open flow connection with the tested working connection AA during the modulation of the test control signal ST. If, therefore, the actual pressure pIst and/or actual slip sIst and/or actual deceleration zIst determined in the third localization step ST2.3 for a working connection AA deviates too strongly from the test target pressure pTSoll encoded in the test control signal ST or the resulting target slip sSoll or the target deceleration zSoll, then a leak L can be located at the relevant pressure line D which is assigned to this working connection AA with dW>TL.

In a subsequent reaction step ST3, during the existence of a braking demand B, a detected leak L, as shown for example in FIGS. 2, 3, 4, is reacted to as follows:

If a previously detected leak L could not be located in the localization step ST2, at least a first leak signal SL1 is output in a first reaction step ST3.1. The first leak signal SL1 can then be used, for example, to communicate that a leak L has been detected, but the position could not be determined. The automation system 12 can then change the strategy thereof for generating and outputting the braking demand B accordingly.

If the detected leak L could also be localized in localization step ST2, then in a second reaction step ST3.2 it is determined whether the respective affected pressure channel or the respective affected pressure line D can be shut down in a minimally invasive manner during the presence of a braking demand B. This means that the respective pressure line D affected by the leak L is no longer subjected to a working pressure pA by the modulators M, for example by permanently bringing the integrated inlet valve/outlet valve combination for the affected working connection AA into a pressure holding position (inlet valve and outlet valve closed) regardless of the existing braking demand B and holding it in that position.

Minimally invasive means that the reduction in the braking performance of the vehicle 1 resulting from the shutdown of the respective pressure channel or the respective pressure line D and the resulting influences on the lateral dynamics can be largely compensated or at least sufficiently reduced by other measures. For this purpose, a shutdown criterion AK for the respective affected pressure channel is checked as follows:

First, in a first test step ST3.2.1, the deceleration loss Vz that would result from a shutdown of the pressure channel affected by the leak L or the pressure line D affected by the leak L in the presence of a braking demand B is estimated. This can be carried out by an estimate in the brake control unit 10, taking into account the pressure channels/pressure lines D that are still available and not affected by the leak L, or by measuring the actual deceleration zIst of the vehicle 1 with and without using the affected pressure channel or the respective affected pressure line D.

In a second test step ST3.2.2, it is then checked whether the deceleration loss Vz during a braking demand B can be compensated by at least one of the other, unaffected pressure channels, for example by transferring a compensated target pressure pKSoll to one or more modulators M via the respective electrical control signal SE instead of the target pressure pSoll resulting from the braking demand B alone. The compensated target pressure pKSoll must then be determined in such a way that a correspondingly adjusted or increased working pressure pA is provided and modulated at one or more of the other working connections AA not affected by the leak L, which takes into account both the braking demand B and the loss due to the shutdown of the respective pressure channel.

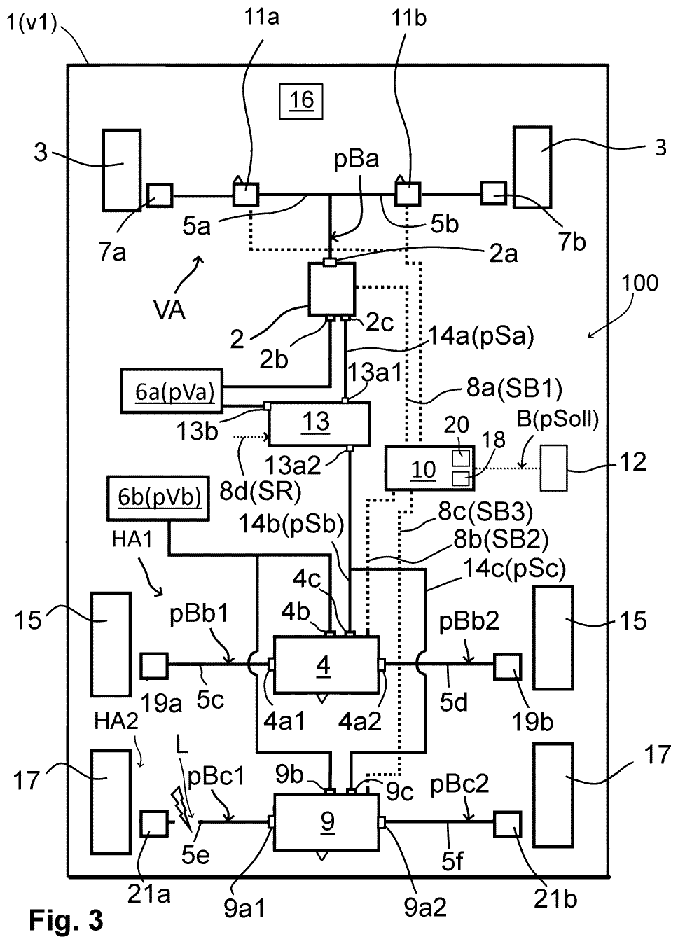

In an optional third test step ST3.2.3, it is checked which lateral dynamic influences result from a shutdown of a pressure channel and/or from the associated compensation by another pressure channel. If, for example, the first working connection 9a1 of the third axle modulator 9 is shut down due to a leak L in the fifth brake pressure line 5e, as shown in FIG. 3, this can already influence the lateral dynamics of the vehicle 1, since there is no brake intervention on one side. This influence is intensified if, for example, the resulting loss of braking effect is compensated by an increase in pressure at the second working connection 9a2 of the third axle modulator 9.

During the third test step ST3.2.3, a lateral dynamic influence Q resulting from the shutdown of one pressure channel and the compensation of the deceleration loss Vz by at least one other pressure channel is estimated, for example in the form of a yaw rate Y and/or a lateral acceleration aQ. This can be carried out, for example, by a stability system 20 as part of the brake control unit 10. In addition, it can be assessed whether the lateral dynamic influence Q can at least be reduced or completely compensated, for example by restricting the compensated target pressure pKSoll only to certain modulators M or to certain working connections AA and/or by limiting the magnitude of the compensated target pressure pKSoll. For example, it can be assessed whether an increased working pressure pA can only be modulated from those working connections AA that are not directly affected by the leak L and are assigned to the same side of the vehicle as the working connection AA directly affected by the leak L, in order to keep a change in the yaw rate Y as small as possible.

It can also be taken into account whether the deactivation results in one-sided braking on the front axle VA or on one of the rear axles HA1, HA2, which normally has different effects on the lateral dynamics of the vehicle due to the different axle loads and/or the different axle behavior in the case of one-sided braking. In addition or alternatively, it can be assessed whether the lateral dynamic influence Q remaining from the shutdown and possible compensation can be compensated by an automated control of an electric steering system 16 in the vehicle 1 with a corresponding steering demand AL.

In a fourth test step ST3.2.4, depending on whether the deceleration loss Vz can be compensated by a corresponding specification of a compensated target pressure pKSoll via the respective electrical control signal SE, preferably also by reducing or compensating the lateral dynamic influence Q, meeting or not meeting the shutdown criterion AK is output. The shutdown criterion AK is met, for example, if at least the deceleration loss Vz can be compensated. The shutdown criterion AK is continuously checked during a braking demand B, as there may be braking situations in which the result of the test may be different under certain circumstances and the resulting reaction (cf. ST3.3) may also change accordingly.

If the deceleration loss Vz cannot be compensated, it is also taken into account for meeting the shutdown criterion AK that without a shutdown of the pressure channel affected by the leak L or the affected pressure line D, influences on other pressure channels or pressure lines D cannot be ruled out. Pressure media can escape from the respective pressure medium supply 6 via the leak L in the respective pressure line D if a flow connection is established with the leak L via the respective modulator M by a corresponding control of the inlet valve/outlet valve combination (pressure build-up position). This then also has repercussions on other pressure channels or pressure lines D that are connected to the same pressure medium supply 6 or are supplied by it, since the respective supply pressure pV, from which the working pressure pA is modulated, is reduced. The method is therefore particularly advantageous if at least two modulators M or working connections AA are connected to the same pressure medium supply 6 or are supplied with pressure medium from it, since the influence of a leak L on the respective other modulator M or working connection AA can be excluded by a corresponding subsequent reaction.

In this respect, meeting the shutdown criterion AK can also be output if the deceleration loss Vz cannot be fully compensated, but for example additionally defined shutdown conditions AB are implemented in order to avoid a negative effect on the other pressure channels while at the same time ensuring safe operation. Shutdown conditions AB can be, for example, a limitation of the speed v1 of the vehicle 1 and/or at least a partial lifting (unloading) of the respective affected vehicle axle if it is implemented as a lift axle (here for example the two rear axles HA1, HA2). By lifting the affected vehicle axle, the axle loads on the defect-free (braked) vehicle axles can be increased, whereby a high actual deceleration zIst of the vehicle 1 can be further ensured.

Furthermore, it can be taken into account that in the event of a leak L in the control pressure lines 14 between the redundancy modulator 13 and the respective axle modulator 2, 4, 9 and in the event of a shutdown of the working connections 13a1, 13a2 of these pressure channels/control pressure lines 14, only the redundant control is omitted, but the vehicle 1 can continue to brake in normal mode without a loss of pressure by means of the respective axle modulator 2, 4, 9. The first axle modulator 2, which is connected to the same first pressure medium supply 6a as the redundancy modulator 13, is also not affected by a loss of pressure in normal operation, since the control pressure lines 14 are not pressurized with a pressure in normal operation and therefore no pressure medium escapes from the first pressure medium supply 6a via the leak L in the respective control pressure line 14. In this respect, even if compensation for the deceleration loss Vz cannot be made in the case of redundancy (cf. ST3.2.2), the shutdown criterion AK can be output as met for these working connections 13a1, 13a2 or pressure channels/control pressure lines 14. For this purpose, too, a limitation of the speed v1 of the vehicle 1 can be specified as a shutdown condition AB in order to react to limited functionality at the fallback level.

In a third reaction step ST3.3, if the shutdown criterion AK is met, the pressure channel in question is then permanently deactivated, that is, the respective pressure line D affected by the leak L is no longer subjected to a working pressure pA by the modulators M, for example by permanently switching the integrated inlet valve/outlet valve combination upstream of the affected working connection AA to a pressure holding position (inlet valve and outlet valve closed), regardless of the existing braking demand B, and holding it there. Optionally, it can be provided that the respective pressure channel is only deactivated if at least one other pressure channel remains in the corresponding pressure circuit or on the respective vehicle axle and can also be operated, such as on the two rear axles HA1, HA2. In the present case, there is at least a redundant control on the front axle VA by means of the redundancy modulator 13. This ensures that the vehicle 1 can continue to be braked in several pressure circuits.

If the shutdown criterion AK is not met, all pressure channels accordingly remain activated, that is, unchanged.

At the same time as an affected pressure channel is deactivated, a compensated target pressure pKSoll is then output to at least one modulator M, preferably under the control of the stability system 20, via the respective electrical control signal SE, in order to apply a correspondingly adjusted, in particular increased, working pressure pA to the respective working connection(s) AA not directly affected by the leak L for a compensation of the deceleration loss Vz. By using the stability system 20, the lateral dynamic influence Q is reduced or, ideally, fully compensated by a corresponding steering demand AL to the steering system 16, as described above. In subsequent braking, the compensated target pressure pKSoll, which is determined both depending on the braking demand B and the deactivation/failure of the respective pressure channel, is always taken into account in the pilot controller, so that the remaining pressure channels initially carry out a higher or adapted pressure control and the partial failure can be compensated better or faster.

At the same time as the deactivation of the affected, previously localized pressure channel or the respective pressure line D and the adjusted pressure modulation at the remaining pressure channels, a second leak signal SL2 is generated and output. The second leak signal SL2 can then be used, for example, to communicate that a leak L has been detected and that the pressure channel in question has also been deactivated or shut down. The second leak signal SL2 can be output to the automation system 12, which can then change the strategy thereof for generating and outputting the braking demand B accordingly, for example depending on the resulting degradation of the deceleration power. For example, it may be envisaged to initiate a corresponding minimum risk maneuver or to reschedule the mission, route or trajectory of the vehicle 1 accordingly in order to react to the degradation of the deceleration power.

During the deactivation of the affected, previously located pressure channel or the respective pressure line D, the shutdown criterion AK and the driving operation of the vehicle 1 are continuously monitored as described. The indication step ST1 and/or the localization step ST2 can also be repeated at regular intervals to validate the occurrence and/or position of a previously detected leak L. If the occurrence of a leak L can no longer be validated subsequently and/or if the result of the test of the shutdown criterion AK has changed due to a different driving situation, normal braking operation can be resumed, that is, no more pressure channels are deactivated or adapted, compensating pressure control is no longer carried out in order to implement the braking demand B normally and without compensation. However, even without deactivating a pressure channel, the shutdown criterion AK is continuously checked and/or the indication step ST1 and/or the localization step ST2 is carried out again in order to react to a changing situation.

Furthermore, it may be provided that a detected and/or located leak L or the fault reaction thereto are stored in a (non-volatile) fault memory 18 of the brake system 100, for example in the brake control unit 10. It can be ensured that even after starting/restarting the brake system 100, it is possible to start directly with the fault-optimized adapted brake pressure control with the respectively compensated target pressure pKSoll when the respective pressure channel is deactivated.

According to an embodiment, this configuration of the brake system 100 can also be used to detect a leak L between one of the ABS valves 11a, 11b and the respective brake cylinder 7a, 7b on the front axle VA by determining the system reaction resulting in the localization step ST2 from suitably specifying a test demand pressure pTSoll for the first and second brake pressure lines 5a, 5b and controlling the ABS valve 11a, 11b (alternating pressure build-up and pressure maintenance). From this, it can be concluded that there is a leak L in the respective brake pressure line 5a, 5b between the respective ABS valve 11a, 11b and the respective brake cylinder 7a, 7b on the front axle VA (actual-target comparison). As a reaction, the respective ABS valve 11a, 11b can then be permanently switched to the pressure holding position in order to deactivate this pressure channel, that is, this part of the brake pressure line 5a, 5b, and thus prevent an escape of the pressure medium.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle
2 First axle modulator
2a Working connection of the first axle modulator 2
2b Pressure medium connection of the first axle modulator 2
2c Redundancy connection of the first axle modulator 2
3 Wheel of the front axle VA
4 Second axle modulator
4a1 First working connection of the second axle modulator 4
4a2 Second working connection of the second axle modulator 4
4b Pressure medium connection of the second axle modulator 4
4c Redundancy connection of the second axle modulator 4
5 Brake pressure line
5a First brake pressure line
5b Second brake pressure line
5c Third brake pressure line
5d Fourth brake pressure line
5e Fifth brake pressure line
5f Sixth brake pressure line
6 Pressure medium supply
6a First pressure medium supply
6b Second pressure medium supply
7a Left brake cylinder on the front axle VA
7b Right brake cylinder on the front axle VA
8 Electrical control cable
8a First electrical control cable
8b Second electrical control cable
8c Third electrical control cable
8d Fourth electrical control cable
9 Third axle modulator
9a1 First working connection of the third axle modulator 9
9a2 Second working connection of the third axle modulator 9
9b Pressure medium connection of the third axle modulator 9
9c Redundancy connection of the third axle modulator 9
10 Brake control unit
11a ABS valve of the left front wheel
11b ABS valve of the right front wheel
12 Automation system
13 Redundancy modulator
13a1 First working connection of the redundancy modulator 13
13a2 Second working connection of the redundancy modulator 13
13b Pressure medium connection of the redundancy modulator 13
14 Control pressure line
14a First control pressure line
14b Second control pressure line
14c Third control pressure line
15 Wheel of the first rear axle HA1
16 Steering system
17 Wheel of the second rear axle HA2
18 Fault memory
19a Left brake cylinder on the first rear axle HA1
19b Right brake cylinder on the first rear axle HA1
20 Stability system
21a Left brake cylinder on the second rear axle HA2
21b Right brake cylinder on the second rear axle HA2
100 Brake system
AA Working connection
AB Shutdown condition
AK Shutdown criterion
AL Steering demand
aQ Lateral acceleration
B Braking demand
D Pressure line
dW Deviation
dp Pressure deviation
ds Slip deviation
dz Deceleration deviation
HA1 First rear axle
HA2 Second rear axle
L Leak
M Modulator
PA Working pressure
pBa First brake pressure
pBb1 Left second brake pressure
pBb2 Right second brake pressure
pBc1 Left third brake pressure
pBc2 Right third brake pressure
pSoll Target pressure
pTSoll Test target pressure
pKSoll Compensated target pressure
pIst Actual pressure
pv Supply pressure
pVa First supply pressure
pVb Second supply pressure
Q Lateral dynamics variable
SB1 First brake control signal
SB2 Second brake control signal
SB3 Third brake control signal
SK Compensation control signal
SL1 First leak signal
SL2 Second leak signal
SR Redundancy control signal
ST Test control signal
sIst Actual slip
sSoll Target slip
TI Indication threshold value
TL Localization threshold value
v1 Speed of the vehicle 1
VA Front axle
WIst Actual value
WSoll Target value
Y Yaw rate

1. A method for controlling a brake system of a vehicle, wherein the brake system has at least two modulators each configured to modulate a working pressure via a corresponding one of the at least two modulators, depending on a specified braking demand, from a supply pressure prevailing in a pressure medium supply assigned to the corresponding one of the at least two modulators and the working pressure is configured to be provided at one or more working connections of the corresponding one of the at least two modulators, wherein at least one pressure line is connected to the corresponding one of the working connections, the method comprising:
determining whether there is a leak in the brake system;
localizing a detected leak by:
controlling at least one of the at least two modulators with a test control signal such that there is a change in the working pressure provided as a function of a present braking demand at the working connection to be tested of the corresponding one of the at least two modulators; and,
determining a deviation between a target value specified as a function of the test control signal and an actual value assigned to the working connection to be tested, which is set as a result of said controlling the at least one of the at least two modulators with the test control signal;
wherein, in an event that the determined deviation exceeds a localization threshold, the leak is located in the pressure line which, during the control of the corresponding one of the at least two modulators with the test control signal, has an open flow connection with the working connection to which this localization threshold-exceeding deviation is assigned;
controlling at least one of the at least two modulators of the brake system such that:
a flow connection between the pressure line with the located leak and the pressure medium supply from which the working pressure for the one or more working connections connected to this pressure line is modulated is interrupted; and,
at the one or more working connections to which no pressure line with the located leak is connected, an adjusted working pressure is provided, which depends on the specified braking demand and on a deceleration loss resulting from the interruption of the flow connection to the pressure line with the located leak.

2. The method of claim 1, wherein the actual value assigned to the working connection to be tested is at least one of:
an actual deceleration resulting from the control of the corresponding one of the at least two modulators with the test control signal for the vehicle;
an actual slip which results from the control of the corresponding one of the at least two modulators with the test control signal on a wheel assigned to the respective working connection to be tested; and,
an actual pressure resulting from the control of the corresponding one of the at least two modulators with the test control signal at the working connection to be tested or in the pressure line connected to the working connection to be tested.

3. The method of claim 2, wherein the deviation is at least one of:
a pressure deviation between a test target pressure and the actual pressure;
a slip deviation between a target slip resulting from the test target pressure and the actual slip; and,
a deceleration deviation between a target deceleration of the vehicle resulting from the test target pressure and the actual deceleration of the vehicle.

4. The method of claim 3, wherein the test target pressure is encoded in the test control signal.

5. The method of claim 1, wherein, at the one or more working connections to which no pressure line with the located leak is connected, an adjusted working pressure is provided as a function of the braking demand such that the deceleration loss resulting from the interruption of the flow connection to the pressure line with the located leak is fully offset or at least reduced.

6. The method of claim 1, wherein, at the one or more working connections to which no pressure line with the located leak is connected, an adjusted working pressure is provided as a function of the braking demand such that a lateral dynamic influence resulting from an interruption of the flow connection to the pressure line with the located leak is fully offset or at least reduced.

7. The method of claim 6, wherein the working pressure at the one or more working connections to which no pressure line with a located leak is connected is limited to limit the lateral dynamic influence resulting therefrom.

8. The method of claim 6, wherein a steering demand is additionally output to a steering system in the vehicle; the steering demand is generated such that the lateral dynamic influence resulting from an interruption of the flow connection to the pressure line with the located leak is offset or at least reduced.

9. The method of claim 8, wherein the steering demand is generated in coordination with the adjusted working pressure.

10. The method of claim 1, wherein after the localization of the detected leak, the specified braking demand is adjusted depending on the detected deceleration loss.

11. The method of claim 1, wherein after the localization of the detected leak, the specified braking demand is reduced depending on the detected deceleration loss such that the deceleration loss resulting from the interruption of the flow connection to the pressure line with the located leak is configured to be fully offset or at least reduced by providing an adjusted working pressure to the one or more working connections to which no pressure line with the located leak is connected.

12. The method of claim 1 further comprising:
checking a shutdown criterion for the one or more working connections to which the pressure line with the located leak is connected after said localizing the detected leak; and,
wherein the flow connection to the pressure line with the located leak is only interrupted if the shutdown criterion is met.

13. The method of claim 12, wherein, in order to meet the shutdown criterion, it is checked whether an adjusted working pressure is providable at the one or more working connections of the respective modulator to which no pressure line with the located leak is connected, such that if there is a braking demand, the deceleration loss resulting from the interruption of the flow connection to the pressure line with the located leak is configured to be fully offset or at least reduced.

14. The method of claim 13, wherein, in order to meet the shutdown criterion, it is additionally checked whether a further working pressure for a further working connection of at least one of the same modulator and another modulator of the brake system is being modulated from the pressure medium supply from which the working pressure is modulated for the one or more working connections connected to the pressure line with the located leak.

15. The method of claim 14, wherein the shutdown criterion is met if the additional check is affirmed and the deceleration loss is configured to at least be reduced by an adjusted working pressure.

16. The method of claim 12, wherein in order to meet the shutdown criterion, it is additionally checked whether the pressure line with the located leak is assigned to a front axle or a rear axle for estimating the deceleration loss.

17. The method of claim 12, wherein when the shutdown criterion is met, at least one shutdown condition is additionally specified and output.

18. The method of claim 17, wherein the shutdown criterion includes at least one of a limitation of the speed of the vehicle, at least a partial lifting of the respective affected vehicle axle, and an adjustment of the trajectory planning.

19. The method of claim 1, wherein the test control signal is generated such that:
if there is a braking demand of zero, the working pressure at the corresponding working connection to be tested is increased; or,
if there is a braking demand of non-zero, the working pressure at the corresponding working connection to be tested is reduced.

20. The method of claim 19, wherein the working pressure at the corresponding working connection to be tested is increased at least one of in a pulse-like manner and to 500 mbar; or, the working pressure at the corresponding working connection to be tested is reduced at least one of in a pulse-like manner and to ambient pressure.

21. The method of claim 19, wherein when the working pressure is reduced at the respective working connection to be tested, a compensation control signal is generated and output to at least one of the modulators such that the working pressure provided at the respective untested working connection is increased to compensate for the reduction of the working pressure at the respective working connection to be tested.

22. The method of claim 21, wherein the method is stopped or paused if, as a result of the control with the compensation signal, the working pressure provided at the respective untested working connection cannot be further increased.

23. The method of claim 1, wherein during the localization of the detected leak, the test control signal is generated and output such that a change in the working pressure results from the test control signal only at the working connection to be tested within the brake system.

24. The method of claim 1, wherein said determining whether there is a leak in the brake system is carried out by determining, in the presence of a non-zero braking demand, whether a target value specified as a function of the non-zero braking demand is different by more than an indication threshold from an actual value which is set as a result of the control of the respective modulator with the braking demand present.

25. The method of claim 1, wherein at least one of the detection of the leak and the localization of the leak is continuously checked.

26. The method of claim 1, wherein at least one of the detected leak and the located leak is placed in a non-volatile fault memory of the brake system.

27. The method of claim 1, wherein the braking demand is specified automatically.

28. The method of claim 1, wherein the braking demand is specified automatically by an automation system.

29. A brake control unit for a brake system, wherein the brake system has at least two modulators each configured to modulate a working pressure via a corresponding one of the at least two modulators, depending on a specified braking demand, from a supply pressure prevailing in a pressure medium supply assigned to the corresponding one of the at least two modulators and the working pressure is configured to be provided at one or more working connections of the corresponding one of the at least two modulators, wherein at least one pressure line is connected to the corresponding one of the working connections, the brake control unit comprising:
a processor;
a non-transitory computer readable medium having program code stored thereon;
said program code being configured, when executed by said processor, to:
determine whether there is a leak in the brake system;
localize the detected leak by:
controlling at least one of the at least two modulators with a test control signal such that there is a change in the working pressure provided as a function of a present braking demand at the working connection to be tested of the corresponding one of the at least two modulators; and,
determining a deviation between a target value specified as a function of the test control signal and an actual value assigned to the working connection to be tested, which is set as a result of said controlling the at least one of the at least two modulators with the test control signal;
wherein, in an event that the determined deviation exceeds a localization threshold, the leak is located in the pressure line which, during the control of the corresponding one of the at least two modulators with the test control signal, has an open flow connection with the working connection to which this localization threshold-exceeding deviation is assigned;
control at least one of the at least two modulators of the brake system such that:
a flow connection between the pressure line with the located leak and the pressure medium supply from which the working pressure for the one or more working connections connected to this pressure line is modulated is interrupted; and,
at the one or more working connections to which no pressure line with the located leak is connected, an adjusted working pressure is provided, which depends on the specified braking demand and on a deceleration loss resulting from the interruption of the flow connection to the pressure line with the located leak.

30. A vehicle having a brake system comprising the brake control unit of claim 29.
